(19) United States
(12) Patent Application Publication
(10) Pub. No.: US 2007/0226540 A1
(43) Pub. Date: Sep. 27, 2007

(54) Knowledge-Based Diagnostic System for a Complex Technical System, Comprising Two Separate Knowledge Bases for Processing Technical System Data and Customer Complaints

(75) Inventor: Martin Konieczny, Althengstett-Ottenbronn (DE)

Correspondence Address: FITCH, EVEN, TABIN & FLANNERY, P. O. BOX 18415, WASHINGTON, DC, 20036, US

(73) Assignee: DaimierChrysler AG, 70567 Stuttgart (DE)

(21) Appl. No.: 11/596,456

(22) PCT Filed: May 4, 2005
(86) PCT No.: PCT/EP05/04816

§ 371 Date: Jan. 31, 2007

(30) Foreign Application Priority Data
May 15, 2004 (DE) 10 2004 24 262.3

(51) Int. Cl. G06F 11/00

(52) U.S. Cl. 714/26

(57) ABSTRACT

The present document describes a diagnostic system for localizing faults in diagnostics in a workshop. The diagnostic system takes into account both trivial and costly intermittent fault situations. It is characterized by a structured module concept for the software architecture. Division into localization of quasi-steady-state and intermittent faults is carried out by reference to classification of the diagnostic tasks. The first-mentioned problems can be solved by means of a systematic procedure using all the available information. The modular software architecture with strict separation of protected data and imprecise information supports the guided troubleshooting process. Current methods which operate according to the prior art are used in individual modules of the software architecture. The advantages of the known system diagnostics, such as compression of the suspected components are utilized and expanded. The inventive addition of symptom processing improves the result of previous systems for system diagnostics. The improved guidance during the system diagnostics helps to avoid removing satisfactory components. Generation of dynamic test step trees is innovatively used for efficient fault localization. In the known system diagnostics, intermittent faults give rise to long troubleshooting times owing to the necessary reproducibility of the fault. The diagnostic system according to the invention supports the localization of the intermittently occurring faults by also logging in temporary onboard diagnostics or temporary remote diagnostics with subsequent evaluation in the workshop. The significant advantage of this method is the fact that the customer is not deprived of his vehicle during the fault localization process.

The invention relates to a diagnostic system from the category of model-based system diagnostics. In these computer-supported diagnostic systems, the technical system to be analyzed is mapped with a computer-processable model and is monitored for the occurrence of faults by means of sensors and fault detection algorithms. The faults are codified and evaluated by means of a knowledge base which contains the diagnostic knowledge relevant for the computer-supported diagnostics, and by means of a diagnostic system. The evaluation is based here essentially on the fault code which is determined, and the diagnostic system identifies, from the knowledge base, the set of fault candidates assigned to the fault code. In a further step, the number of fault candidates is reduced to a minimum by using what are referred to as fault environment data, that is to say further system data which is present during the occurrence of the fault, and taking it into account by means of fault-specific exclusion criteria from the diagnostic system. Alternatively, the remaining fault candidates can also be evaluated and weighted by the diagnostic system.

Various versions of such model-based diagnostic systems are known from the prior art.

DE 195 23 483 A1 discloses a model-based, computer-supported diagnostic system which corresponds to the preamble of the independent claim and in which the formation of models comprises a structure model and an action model, which is often also termed a behavior model. The physical relationships between the individual components of the technical system are mapped with the structure model and the functions of the individual components of the technical system are mapped with the behavior model. The diagnostic knowledge which is relevant to the diagnosis is stored in a knowledge base. Fault detection can be carried out with the diagnostic system and computer-supported troubleshooting can be carried out by recourse to the knowledge base. The diagnostic system itself has in this case only and exclusively access to fault environment data from the technical system and to a knowledge base which is aimed exclusively at the fault-specific evaluation of the technical system data. Customer complaints or symptomatic fault descriptions can only be taken into account by menu guiding—carried out by an experienced service technician—if the technical system data and the fault environment data does not permit any unambiguous diagnosis or any diagnosis at all to be carried out by the diagnostic system.

Another possibility for model formation, as it is understood under the term of model-based system diagnostics in the sense of this invention, is disclosed in detail, for example, in EP 1 069 487 B1. Here, the technical system on which diagnostics is to be performed is mapped and modeled for the computer-supported diagnosis with a probability network, referred to as a Bayes network. Model formation with probability networks has the advantage that the model formation can be carried out at a functional level of the individual components of the system. The individual components themselves do not need to be modeled onto a physical structure model. However, the price paid for this advantage is the problem of finding the correct a priori probabilities of the Bayes network. A probability distribution which maps the system states within the probability network is calculated by means of a knowledge base in accordance with a fault message which has been found, and a fault diagnosis is made on this basis using the diagnostic system, and a remedying measure which fits this fault diagnosis is proposed. In order to improve the diagnostic result, question nodes are integrated in the probability network which permit simple yes/no questions to be posed to a user of the diagnostic system by means of a man-machine interface during the diagnostic sequence. By answering the questions, evident knowledge is interrogated in the diagnostic sequence at decisive network nodes and introduced into the diagnostic sequence with the consequence that the diagnostic result is decisively improved using this evident knowledge. However, only evident knowledge whose interrogation was provided for by the system designer and has been implemented in the form of a question node in the model formation can be included. After the interrogated evident knowledge has been integrated, a probability distribution is calculated within the network and the most probable cause of the fault is concluded therefrom taking into account said knowledge and taking into account a knowledge base which contains the functional technical relationships between the individual components of the technical system.

The expenditure on the modeling for the model-based system diagnostics is high. In particular, the quality of the diagnostic result depends decisively on the modeling. For this reason, alternatives to model-based system diagnostics are also sought. Such an alternative is a symptom-based approach such as is described, for example, in DE 102 35 416 A1. In the symptom-based approach, modeling of the technical system is dispensed with. Instead, simple, for example acoustic, symptoms are recorded and compared with already existing patterns. If a known pattern is found for a symptom which occurs, the diagnostic process is largely ended. The set of fault candidates which is assigned to the pattern which has been found is then examined until the precise fault has been found.

The problem with all the computer-supported diagnostic systems described above is that they are only capable of processing predefined, and thus known, fault messages and complaints. This also makes the costly modeling necessary since attempts always have to be made to register and map all the possible complications during the actual design of the diagnostic system. And even then it is not possible for customer complaints which have of course been described only in terms of symptoms without technical detailed knowledge to be processed in a computer-supported fashion and used for the diagnostic process.

This has two decisive disadvantages. On the one hand, there is a risk of the fault space in which the set of fault candidates is to be sought is not extended far enough. This risk is particularly large whenever a fault which is reported by a customer is intermittent, that is to say only occurs occasionally and not permanently. Such faults cannot be found by known, computer-supported diagnostic systems since they rely on the presence of a fault code and extend the fault space around the fault code.

The second disadvantage is the loss of information which occurs if the customer experience is not used or is used only insufficiently. This customer experience with a fault symptom which occurs can in fact be used with a correctly extended fault space and with a correctly identified set of fault candidates to narrow down further the set of identified fault candidates. For example, when there is a set of fault candidates “seat controller defective” with a customer complaint “the seat can only be moved upwards”, it is possible to rule out, in a computer-supported fashion, that the actuating motor of the seat mechanics is defective.

Therefore, the object of the invention is to extend existing model-based diagnostic systems to the effect that symptoms which are reported by customers can also be integrated into the computer-supported diagnostic sequence and processed in a computer-supported fashion during the diagnostic sequence.

The object is achieved with a diagnostic system having the features of the independent claim. Advantageous embodiments of the invention are disclosed in the subclaims and in the description of the exemplary embodiments.

The solution succeeds mainly by virtue of the fact that a known, model-based diagnostic system is extended with a second symptom-based branch and a second knowledge base which is filled with the customer complaints using a symptom tree. The symptom tree is necessary in order to convert the wording of the original customer complaint into statements which can be processed by machine and interpreted by the diagnostic system in a computer-supported fashion. Thus, further information in the symptom environment of this symptom is interrogated with the symptom tree to form a symptom which is contained within the customer complaint with the original wording. Here, information about which functions are intact in the symptom environment when a customer complaint is reported is of particular interest since this permits the diagnostic result to be improved quickly and easily during a final evaluation. This final evaluation is embodied here as a set of fault candidatesting off process. A first set of fault candidates is firstly determined with the purely model-based branch. Then, the symptom-based branch of the diagnostic system is used to calculate a second set of fault candidates. The second set of fault candidates can, in particular, contain information about fault candidates which are reported as intact by the customer. At the end, the two sets of fault candidates are set off against one another by excluding the fault candidates which are not diagnosed as being defective simultaneously in both sets of fault candidates.

In one embodiment, the setting off of fault candidates against one another is carried out by excluding the fault candidates which are reported as intact in one of the two sets of fault candidates.

In an alternative embodiment, the setting off of fault candidates against one another is formed by forming intersection sets. Only those fault candidates which are present simultaneously in both sets of fault candidates are taken into account.

In one alternative embodiment which is suitable for model-based diagnostic systems on the basis of Bayes networks, prioritization of the individual fault candidates is carried out in the two sets of fault candidates. During the setting off of the fault candidates against one another, those fault candidates which have the greatest total priority from the two sets of fault candidates are determined.

The advantages obtained mainly with the invention are improved diagnosis. With the system it is possible to process customer complaints in the original sound. The processing of the customer complaints can already be carried out here during the processing of the symptom tree by cooperation with the customer or else only subsequently by the symptom tree being processed by a service technician in the service workshop.

A further advantage of the invention is that with the symptom-based branch of the diagnostic system it is also possible to process intermittently occurring faults. It is also advantageous that the symptom-based branch of the diagnostic system is not tied to any fault codes which are necessary in purely model-based diagnostic systems and have to be supplied by control devices.

In a further advantageous embodiment of the diagnostic system, after the fault candidates have been determined the test step tree which is then necessary in the workshop is composed and formed by the diagnostic system from predefined and stored test step primitives. This permits a test step tree which is as flat and broad as possible to be created dynamically with the progress of the diagnostics in order to support the service technician in the service workshop.

An exemplary embodiment of a diagnostic system according to the invention will be explained in more detail below with reference to figures, in which:

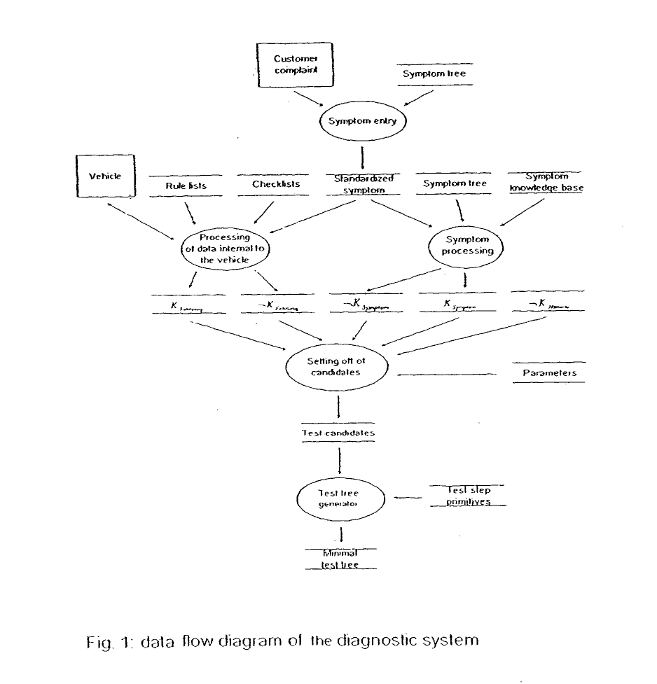

FIG. 1 shows a data flowchart of the diagnostic system,

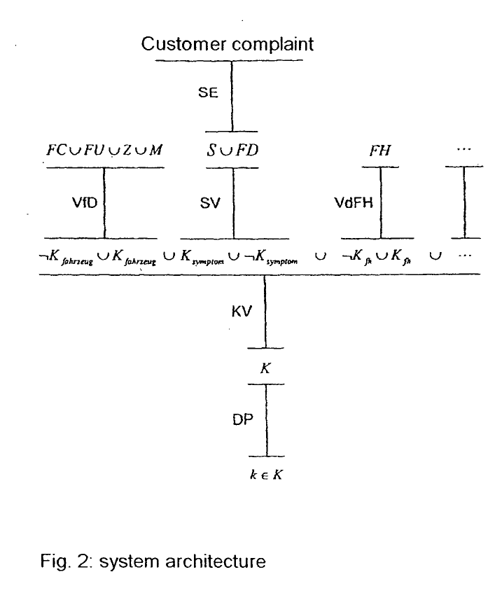

FIG. 2 shows a system architecture,

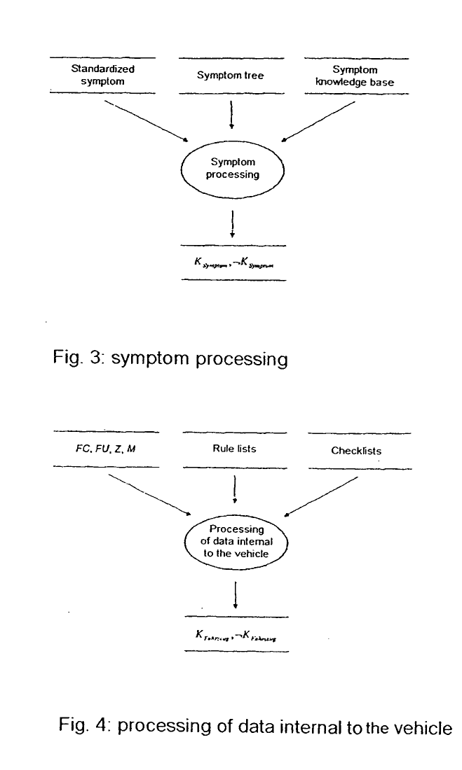

FIG. 3 shows the symptom processing,

FIG. 4 shows the processing of data which is internal to the vehicle,

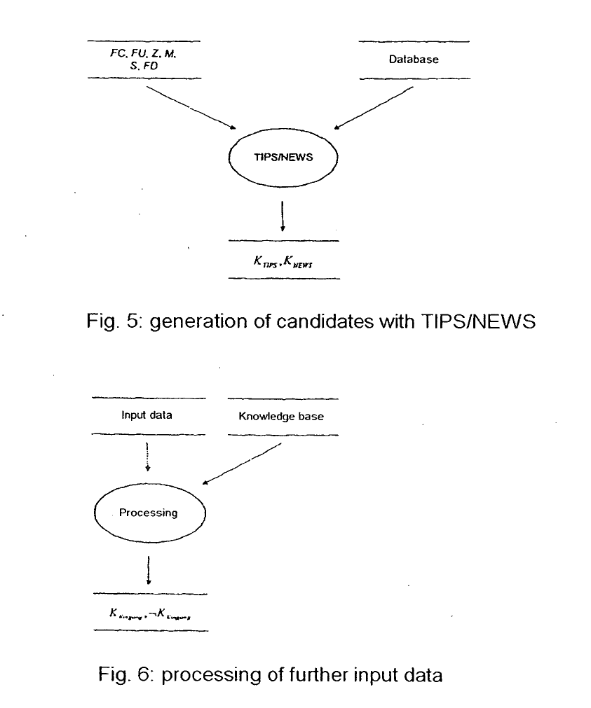

FIG. 5 shows the generation of fault candidates,

FIG. 6 shows the processing of further input data,

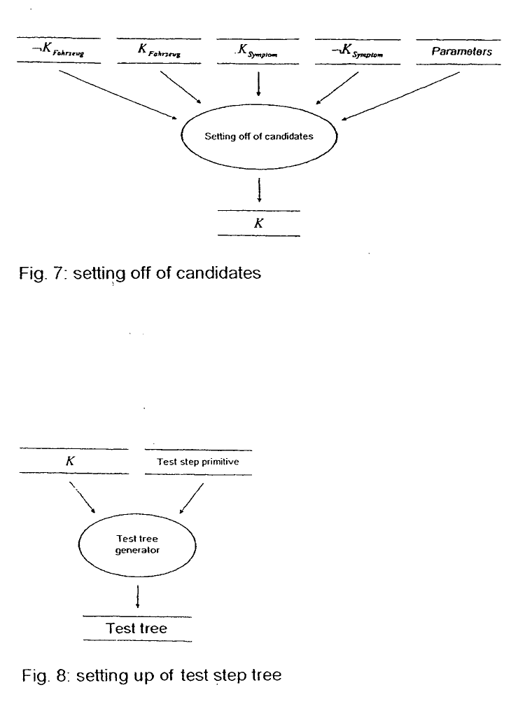

FIG. 7 shows the setting off of fault candidates,

FIG. 8 shows the setting up of the test step tree,

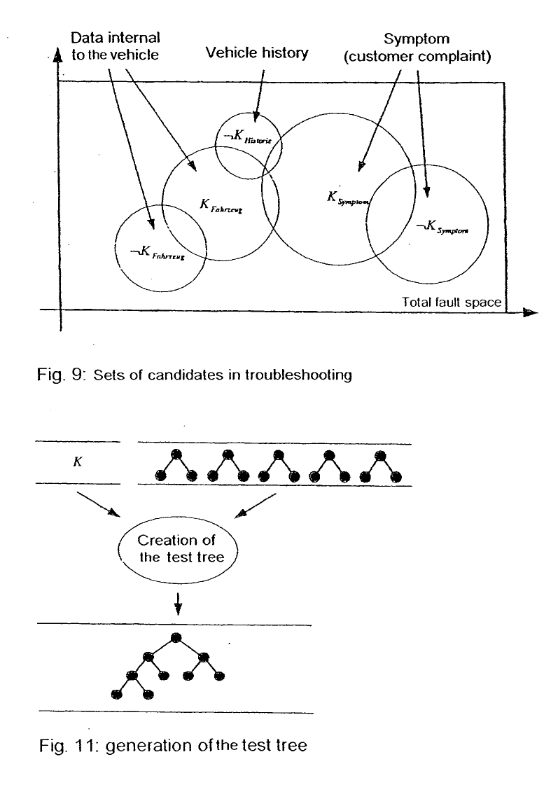

FIG. 9 shows the sets of fault candidates in the fault space,

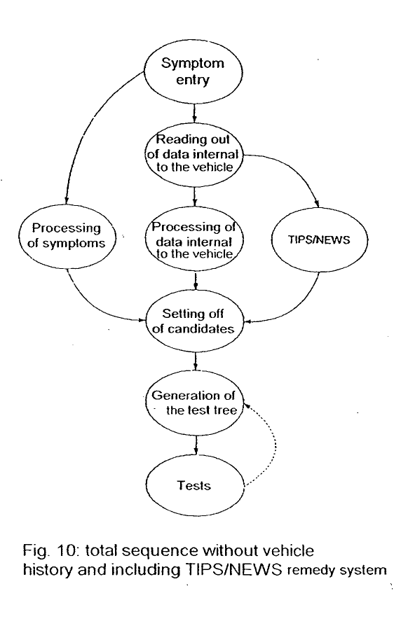

FIG. 10 shows a total sequence of the diagnostic method, and

FIG. 11 shows the creation of the test step tree composed of test step primitives.

The following description discloses the modular system design and the functionalities of the individual modules. The entire interplay between the individual components during troubleshooting is also illustrated.

System Architecture

In order to be able to fulfill the requirements for the best possible flexibility, extendibility, maintenance capabilities and use of current techniques for fault localization, the diagnostic system is firstly divided into seven modules:
Processing of data which is internal to the vehicle (is an extension of contemporary system diagnostics). The diagnostic system automatically evaluates information which is internal to the vehicle in order to generate fault candidates. Vehicle data can cause fault candidates to be attributed and discounted.
Symptom entry. The transfer of the customer complaint, that is to say of the original problem description by the customer, into a technical problem description in standardized form is referred to as the symptom entry. If the customer specifies intact functionalities, they must also be standardized in a suitable form.
Symptom processing. Fault candidates are generated on the basis of the information of the DMS (Dealer Management System) as well as of the symptom entry. The customer statements about intact functions can also be processed at this point.
Setting off of fault candidates against one another. The fault candidates which are generated from the symptom processing, the processing of data which is internal to the vehicle and possibly from further, preceding information processing operations have to be set off against one another. The setting off process determines a set of fault candidates including weighting of the individual elements.
Dynamic creation of test step trees. The fault candidates which are determined have to be checked systematically. For this purpose, a test step tree according to the fault candidates is created dynamically. The systematic checking is directed at costs and information content of individual test step primitives. The degree of user guiding decides ultimately whether the tree has to be extended once or whether it will possibly have to be corrected after each check which is carried out.
Processing of the vehicle history. For each stay of the vehicle at a workshop there is a report with the exchanged components etc. This data can simplify the troubleshooting since the probability of a faulty component as the cause drops whenever this component is replaced.
TIPS/NEWS. Before the systematic fault localization process using the guided troubleshooting, an enquiry according to existing remedies to the TIPS/NEWS system is started. Known faults which can be identified unambiguously serve as the basis for the database. The enquiry is based on the currently available input data.

FIG. 1 shows the data flow for the entire information processing operation by reference to the first five modules of the above enumeration. The processing of the history of the vehicle is firstly omitted at this point for reasons of clarity. TIPS and NEWS are handled separately below.

Information from the vehicle and the customer complaint is available as input data. After the processing which has been presented, a test step tree has been created and has to be processed.

FIG. 2 shows the data flow by reference to the sets to be processed. At the same time, the system architecture of the fault localization process is apparent.

The system architecture is defined by a modular design with specified interfaces. The individual components can be replaced and further developed. The possibility of replacement allows the individual processing steps to be adapted to the prior art.

In contrast to FIG. 1, the processing of the vehicle history is integrated into the representation. It is a branch which is parallel to the symptom processing and the processing of data which is internal to the vehicle. In the same way, further data inputs, which all map a type of information onto fault candidates, are possible.

Essentially, FIG. 2 represents at the same time the sequence which can be read from top to bottom. The processing of the data which is internal to the vehicle, of the symptom and of the vehicle history can occur automatically and in parallel. The results of all three processing operations are sets of fault candidates which have to be set off against one another. In the last step, the targeted checking of fault candidates occurs, and thus also the systematic fault localization process.

The individual components of the diagnostic system:

Each module is determined by its external behavior. The input data and output data are clearly defined. Various techniques can be utilized for the processing of data within the individual modules.

Symptom Entry (and Customer Output) Module

The symptom entry is used to standardize the customer complaint in the form of the original sound for further machine processing. A uniquely defined symptom tree has to be used to classify the terms. Said tree refines the terms (symptoms) according to a functional consideration mode. Alternatively, it is easily possible to use for the interface to the customer a specific MMI symptom tree (man-machine interface) which, in the form of a thesaurus or a lexicon, maps the terms from the original sound of the customer complaint onto the technical specialist terms of the workshop staff. The MMI symptom tree is characterized in that the customer statement can be classified in a number of ways. Thus, a distance-measuring radar is associated, for example, both with the engine and with the driving comfort or the operator control elements in the passenger compartment. Since a uniquely defined symptom is required for the further processing, there is an assignment of the entries from the MMI symptom tree to the uniquely defined (actual) symptom tree. Table 0-1 represents the essential characteristics of the symptom entry.

During the manual standardization, the service technician navigates through the symptom tree. The service technician can stop the standardization at any desired stage. If the service technician stops at a relatively high stage, the imprecise symptom provides a relatively large troubleshooting space. For this reason, the repair assumption aims at a statement by the customer which is as detailed as possible.

In principle, the symptom entry can take place directly when the vehicle is accepted. Appropriate functionalities of the diagnostic system have to be made available for this. If the connection to the vehicle is present before the symptom entry or at the time of the symptom entry, the symptoms which are consistent with the vehicle data can be emphasized. This mechanism will be considered in more detail below during the symptom processing operation.

An important extension of the symptom entry is the equivalent processing by the customer of information from the units which are functioning without problems. This information also has to be standardized. Furthermore, in his complaint the customer should also specify whether the problem occurs continuously or sporadically. To a certain extent different fault candidates are attributed as a function of this information, in particular, however, the type of attribution and thus the further procedure during troubleshooting changes. Detailed information on the localization of sporadic faults is given below in the description.

TABLE 0-1
characteristics of the symptom entry

| | |
|---|---|
| Input data: | Customer complaint in original |
| | wording |
| Output data: | Element/elements of the uniquely |
| | defined symptom tree including |
| | information about the state |
| | (permanent, sporadic) |
| Knowledge bases: | Symptom tree, MMI symptom tree, |
| | symptom assignment between the |
| | trees |
| Processing methods: | Manual or completely automatic |
| | symptom entry |

At the symptom entry, the manual assignment between the MMI symptom tree and the symptom tree which is used last for troubleshooting by the diagnostic system is specified consciously as a processing method. In principle, there are a large number of mechanisms which perform automatic classification and assignment of semantic terms. However, automatic methods generally bring further imprecision into the troubleshooting since they operate with similarity criteria. For this reason, at this point manual standardization of the customer complaint is to be recommended, in particular in the customer's presence.

Of course, the customer can also specify a number of symptoms which make the search space more precise or relate to multiple faults. Furthermore, the optional specification of systems which function satisfactorily is desired but not absolutely necessary. The latter inevitably leads to a narrowing down of the fault candidates.

By cooperation with the symptom processing operation it is possible to implement a dialog which directs the inputting of the customer complaint. If, for example, the symptom “seat adjustment forward/rear” is input, the symptom processing operation determines all the suitable fault candidates. On the basis of the fault candidates it is in turn possible to determine all the symptoms which contain at least one of these fault candidates. The customer is questioned about these symptoms and can provide information on them by specifying whether the symptom is continuously present, sporadically present or not present. This restricts the search space. If the customer does not provide any information about this, or only partial information, he under certain circumstances correspondingly degrades the troubleshooting since the search space becomes larger.

Symptom Processing

During symptom processing, the standardized symptom is mapped onto fault candidates. In the same way, customer information which relates to satisfactorily functioning components is processed. The latter information makes it possible to discount fault candidates. Consequently, in particular only the pure symptom processing is described but the representation relates in the same way to the customer information of the intact functions.

In order to evaluate the correct knowledge bases, the vehicle data, in particular the vehicle identification number FIN should also be specified or read out from the context information of the current troubleshooting and taken into account. Since the symptom is based on the customer complaint, it is imprecise or unreliable knowledge.

Different methods can be used to process the symptom. Raum, F.; Schreier, N.; Spöttl, G.: “Die Zukunft computergestützter Kfz-Diagnose. Rechnergeführte Handlangerarbeit oder qualifizierte Facharbeit. [The future of computer-supported motor vehicle diagnostics. Computer-supported non-specialist work or qualified specialist work]”, published by Bertelsmann Verlag, Bielefeld 2002, contains a comparison of various techniques. Inter alia, for example case-based reasoning (CBR) is suitable since it involves imprecise processing. In the case of CBR an attempt is made to use defined similarities to derive the currently present case from an already existing case. Another possibility and very clear method is rule-oriented processing. The relationships between a symptom and the possible fault candidates can easily be stored in the rules. However, in the long run it is subject to limits since only one direct relationship is possible between the two types of information of symptom and fault candidate. In complex systems the relationship cannot be expressed directly since there is actually a complex interplay between a large number of functionalities.

For this reason, a detour via function models is to be recommended for complex technical systems. A suitable technique at this point is to use Bayes networks which permit the relationships between symptoms and fault candidates to be modeled using any desired networks.

Table 0-2 summarizes the processing step of the symptom processing.

TABLE 0-2
characteristics of the symptom processing

| | |
|---|---|
| Input data: | Symptom S, customer information |
| | about intact functions, vehicle |
| | data FD |
| Output data: | Fault candidates K_{Symptom}, discounted |
| | fault candidates [symbol] K_{Symptom} |
| Knowledge bases: | Symptom tree and case basis, |
| | control mechanism, Bayes network |
| Processing methods: | Inference machine, CBR, Bayes |
| | networks, (methods of semantic |
| | web) |

An important property of the symptom processing which is provided is the possibility of setting off candidates against one another on the basis of multiple inputs. A large number of faults are manifest simultaneously in various customer complaints. An example of this is a blown fuse. If such a fault occurs, a plurality of functionalities are disrupted simultaneously. If a number of said functionalities is known to the customer, they can significantly speed up the troubleshooting.

For the symptom processing, the symptom tree (possibly MMI symptom tree or the like) is additionally necessary. This has the advantage that a symptom cannot always be classified down to the smallest differentiation stage. If the symptom is only known at a higher (less precise) classification stage, all the symptoms below it are used in the mapping on to the fault candidates.

A dialog for minimizing the troubleshooting times can be implemented using the symptom processing and the symptom entry.

Processing of Information which is Internal to the Vehicle

When data which is internal to the vehicle is processed, the calculation of fault candidates is carried out by reference to the stored fault codes and their environmental data, the vehicle configuration and the available actual values of the vehicle. If the symptom is known, the evaluation of the relevant control devices takes place. To do this, if possible a relationship has to be set up between the standardized symptom and the affected control devices. By virtue of such information it would not be necessary to consider all the data which is internal to the vehicle but rather the relevant part would be focused on. The focusing on the relevant control devices brings about significant speeding up in communication and thus in the entire process. Table 0-3 summarizes the processing of information which is internal to the vehicle.

TABLE 0-3
characteristics of the processing of
data which is internal to the vehicle

| | |
|---|---|
| Input data: | Fault codes: FC, fault environment |
| | data FU, |
| | state information Z, measured |
| | values M |
| Output data: | Fault candidates K_{Fahrzeug}, intact |
| | components [symbol] K_{Fahrzeug} |
| Knowledge bases: | Control mechanism, physical |
| | models, structure model, causal |
| | functional relationships |
| Processing methods: | Rule-based diagnostics, model- |
| | based diagnostics, theoretical |
| | graph evaluation |

FIG. 4 shows the processing of the data which is internal to the vehicle in a graphic form. At present, the processing of data which is internal to the vehicle takes place onboard. It includes the performance of diagnostics on CAN-B components as well as on CAN power faults. For BR 221 an expansion of the diagnostics to all the CAN and Most components is provided. Starting from BR 204 the processing takes place exclusively off board. In BR 171 the CAN-C region will be covered off board while the CAN-B region will be processed onboard. The modular concept permits the development process which is foreseen.

The current onboard diagnostics (system diagnostics) operate in a rule-oriented fashion and have to be greatly restricted in terms of their scope and their diagnostic depth owing to the resources available. As a result, their full potential is not exploited. On the other hand, situation-related attribution and discounting occurs. As a result of the transfer of the processing of data which is internal to the vehicle, information which is under certain circumstances important is lost, and this has to be compensated. On the other hand, substantially more performance is available so that this processing part can be exploited as well as possible.

The automatic processing of information which is internal to the vehicle can be carried out off board if appropriate interfaces are made available in the vehicle and to the vehicle. Different methods are suitable for automatic processing depending on the problem. For example, it is possible to use rule-oriented or model-based processing. Structural model analyses on physical models permit problem decomposition and investigation of the diagnosibility.

Theoretical graph approaches permit topological evaluation in order to determine the components or function groups involved in the fault. The available resources and the degree of knowledge preprocessing determine the decision about the use of the respective technology. Owing to the defined interface information, the methods can be replaced and a multimodal diagnostic method can be configured.

Case-based reasoning methods can also be used. FIG. 5 provides more details on this aspect with a graphic illustration. The TIPS and NEWS systems are stand-alone software components of case-based reasoning (CBR) which are included in the fault localization. The data record which is present at the beginning and is composed of the information which is internal to the vehicle as well as the system data and vehicle data is transferred to the TIPS and NEWS systems. The systems search through their own knowledge bases for cases which match the input data. If such a case is present, the system signals the presence of a remedy. In the simplest case, the remedy may be output directly, which is however not to be recommended since there is no longer systematic troubleshooting. It is much more important to use the additional information for selective and systematic troubleshooting.

TABLE 0-4
characteristics of the database queries
in TIPS and NEWS during fault localization

| | |
|---|---|
| Input data: | Fault codes FC, fault environment |
| | data FU, state information Z, |
| | measured values M, symptom S, |
| | vehicle data FD |
| Output data: | Today: remedy. In future: fault |
| | candidates K_{TIPS} or K_{NEWS} |
| Knowledge bases: | Database (case basis) |
| Processing methods: | Database search |

Basically, it is not ensured that the search results will not be ambiguous, with the result that the database interrogation under certain circumstances supplies more than one remedy. Since in principle fault candidates are repaired or replaced by means of each remedy, the remedies can safely be mapped onto fault candidates so that in the case of an ambiguous solution they result in a set of fault candidates. By using the creation of a case-specific test tree it is possible to narrow down the set of fault candidates systematically in the further course of the troubleshooting. At this point, it is necessary to integrate the results of TIPS or NEWS into the diagnostic system described here. The corresponding interfaces between the guided fault localization and the TIPS and NEWS systems have to be specified. Table 0-4 describes the most important characteristics of the entire processing step in the fault localization.

For complete integration of TIPS, when a remedy has been found the system must report the fault candidates. Then, the method conceived here can handle the fault candidates in a correspondingly weighted fashion in the same way as all the other fault candidates. FIG. 10 illustrates the complete integration of TIPS/NEWS into the diagnostic system.

Furthermore, the NEWS system contains repair instructions, damage keys for invoicing and spare part numbers. The corresponding information is referenced after successful fault localization has occurred.

Processing of the Vehicle History and Further Input Data

FIG. 6 illustrates the basic extendibility of the diagnostic system by adding further modules. Of particular interest here is the integration of databases which contain information about the vehicle history and thus information about repairs and maintenance which have already been carried out. The vehicle history contains information about repairs which have already been carried out and can be used for the fault localization only to a limited degree. Under certain circumstances, complaints and the exchanged components are apparent from the vehicle history. If a component has been replaced a short time ago, the probability that given the same customer complaint the component which has already been replaced is the cause is relatively low. Instead, the replaced component will be subject to a consequential fault or be a satisfactory component. This means that the component which is now suspected may certainly be defective again, but it is not the cause of the customer complaint.

TABLE 0-5
characteristics of the processing of the vehicle history

| | |
|---|---|
| Input data: | Vehicle data FD |
| Output data: | Sets of fault candidates [symbol] K_{Historie} |
| Knowledge bases: | Vehicle history (today: FDOK |
| | database, in future: LIVE) |
| Processing methods: | Database searching |

The evaluation of the vehicle history is mainly restricted to a database interrogation. On the basis of the vehicle data which serves to identify the vehicle, the interrogation provides the components which have already been replaced. These can serve under certain circumstances to discount fault candidates from the current troubleshooting.

Integrating the processing of the vehicle history should be considered an option for the diagnostic system at this point. The same applies to other methods which are not specified in more detail here and which map, for example, the wear status or the input date of components into the vehicle onto fault candidates. As a result, FIG. 6 illustrates the generally valid extendibility of the diagnostic system by adding further modules.

Setting Off of Candidates

The setting off of candidates reduces the number of fault candidates to be considered. At the same time, the fault candidates to be considered are prioritized. It thus narrows down and evaluates the troubleshooting space. FIG. 7 illustrates the processing operation for the setting off of candidates by means of the most important fault sets involved.

The starting point of the setting off process is formed by the sets of the attribution candidates (K_{Fahrzeug}, K_{Symptoms}, (K_{TIPS}, K_{NEWS})) and discounting candidates ( [symbol] K_{Fahrzeug}, [symbol] K_{Symptom}) which are determined on the basis of the data which is internal to the vehicle and the customer complaint. For the setting off of candidates against one another, in the first step a parameterizable algorithm is implemented which is based on existing diagnostic algorithms from the prior art on the basis of component detection and fault type detection using fault codes. These existing diagnostic systems and their algorithms are expanded with the following aspects:
Attribution candidates which correspond both in the component and in the type of fault and result both from the symptom and from the processing of data which is internal to the vehicle form the most probable cause of a fault.
Within the intersection set (K_{Fahrzeug} ∩ K_{Symptom}) which takes into account the component and the fault type, weighting is carried out in accordance with the probabilities arising from the preceding processing step.
A candidate for the discounted set [symbol] K_{Fahrzeug} or [symbol] K_{Symptom} causes a corresponding attribution candidate to be discounted if the component and fault type correspond.
In the case of different fault types of a component, complete discounting of a fault candidate can occur only if corresponding discounting candidates of the component are present in all the possible fault types. A suitable knowledge space is to be prepared.
If different fault types are attributed to a component in terms of the symptom and in terms of the processing of data which is internal to the vehicle, the attribution of the fault candidate arising from the processing of data which is internal to the vehicle is to be given a higher weighting.

As a further option it is possible for the algorithm to be improved by methods for multi-dimensional optimization problems. Table 0-6 characterizes the setting off of candidates against one another, with not only the already mentioned sets but also the fault candidates from the remedy systems TIPS and/or NEWS being also taken into account. If TIPS and/or NEWS contain remedies relating to the given input data, they are to be provided with the fault candidates under suspicion. The setting off of candidates against one another is performed by the integration of the data.

TABLE 0-6
characteristics of setting off of candidates

| | |
|---|---|
| Input data: | Set of fault candidatess K_{Fahrzeug} |
| | [symbol] K_{Fahrzeug}, K_{Symptom}, [symbol] K_{Symptom}, [symbol] K_{Historie} |
| | (possibly K_{TIPS}, K_{NEWS}) |
| Output data: | Set of candidates K to be checked |
| Knowledge bases: | If appropriate component-based |
| | fault types |
| Processing methods: | Probability-oriented setting off |
| | according to parameterizable |
| | algorithm, method for multi- |
| | dimensional optimization problems |

Case-Specific Generation of the Test Tree

If the setting off of candidates against one another has come to a result and if a set of fault candidates has been determined, the diagnostic system cannot optionally be used to further narrow down the set of fault candidates by recommending a test step tree to the service technician. The test steps are to be used to systematically reduce the set of fault candidates taking into account the testing costs. The objective is fastest possible narrowing down. In order to achieve comprehensible modeling of the tests, the test steps are implemented as primitives. A primitive is here, for example, a checking instruction for the checking of functions of a component which is installed in the motor vehicle or in the case of general faults which relate to a plurality of components. The algorithm of the diagnostic system performs the function of selecting and evaluating the test step primitives and creates a test step tree which is processed in the workshop. The creation is oriented according to
the set (number) of suspected fault candidates,
the fault probabilities of individual fault candidates,
the cost of individual tests,
the fastest possible narrowing down of the fault.

Table 0-7 shows the characteristics of generation of test step trees. FIG. 8 and FIG. 10 illustrate the data flow and the selection of test step primitives in order to create the test step tree.

TABLE 0-7
characteristics of dynamic test steps

| | |
|---|---|
| Input data: | Weighted set of candidates K |
| Output data: | Test step tree in implicit form |
| Knowledge bases: | Test step primitives |
| Processing methods: | Search algorithm with defined |
| | criteria |

As a result there is therefore a test step tree in an implicit form which localizes the fault as a function of the previously determined set of fault candidates taking into account the costs which are incurred. In order to implement the troubleshooting strategy, the structure of the test step primitives must include the elements according to Table 0-8.

TABLE 0-8
data structure of the test step primitives

| Element: | Description |
|---|---|
| Testing | This is the actual testing which |
| | is to be carried out. It can be |
| | implemented as a reference to a |
| | structure which contains a |
| | description, an image and/or a |
| | complex program and thus, for |
| | example, an active test. |
| Test step costs | The test step costs are used to |
| | evaluate the test. Here, the costs |
| | which are actually incurred do not |
| | need to be noted. It is also |
| | possible to work with a cost value |
| | with any desired standardization. |
| | The decisive factor is that said |
| | value is given on the same basis |
| | for each test. |
| Test candidates | Each test pursues the objective of |
| | excluding a set of fault |
| | candidates. By specifying the |
| | fault candidates which are |
| | verified by the test the algorithm |
| | is capable of selecting a test |
| | which contains the currently most |
| | probable fault candidates and as |
| | many other fault candidates as |
| | possible. |

Furthermore, dependencies of the tests have to be taken into account in order to be able to comply with necessary ordering sequences. In future, the tests are to be separated into preceding operations, testing and subsequent operations. The preceding or subsequent operations include, for example, the exposure of a component to be tested. The algorithm is then capable of taking into account these activities. As a result, for example after a component has been removed, all the tests which require this removal can be carried out.

Furthermore, in addition to the test step primitives, it is also possible to provide more complex test structures with a plurality of outputs and different statements. More complex, coherent sequences can be formed by this means. The structures such as the primitives are used by the algorithm in a context-dependent fashion so that an optimum sequence is obtained for the diagnostic process in the workshop.

Fault Localization

The diagnostic system disclosed here pursues the objective of guided troubleshooting. The guidance is carried out in a manner known per se with a screen menu. It will certainly also provide the possibility of a short test and thus of complete data inspection. In such a case, the service technician has the possibility to work past the guidance. This results in enormous costs nowadays because these options provide the service technician with unrestricted room for maneuver during the troubleshooting so that his own systematic comes into play during the troubleshooting. Furthermore, repairs are often based on suspicion. On the other hand, there will always be a short test or access to diagnostic data relating to product classification since the access has to be available for a system check or selective extension of the diagnostic system.

For these reasons, the order on customer acceptance should determine the degree of guidance. If replacement of a previously determined component is requested, diagnostic data can be obtained via access which is to be defined but is direct. However, if the fault is unknown and the order indicates troubleshooting, the described access must be declined and only the guided troubleshooting must be available.

Overall Sequence when Searching for Permanent Faults

Permanent faults may be localized by means of systematic evaluation of the available information using further measurements. At this point the overall troubleshooting sequence should be explained by reference to the data quantities processed in the background.

Guided Troubleshooting

FIG. 9 illustrates the relationship between the individual sets of fault candidates with specification of the diagnostic module from which they have been produced and their relationship with the overall troubleshooting space.

During acceptance of the vehicle, the vehicle data and the customer complaints are registered. The customer complaint is thus available in its original wording and can be mapped onto standardized symptoms. In order to narrow down the troubleshooting space in an optimum way it is possible to specify a plurality of symptoms since many faults are manifest simultaneously in different symptoms. The differentiation in a symptom which is permanently or sporadically present helps in specifying the fault type. Basically, at this point it is also conceivable to specify system components which function satisfactorily and which would lead to significantly faster troubleshooting by excluding fault candidates.

The symptom entry can take place at the vehicle acceptance (Dealer Management System). However, since there are twelve different acceptance systems throughout the world, the symptom entry may under certain circumstances have to be performed manually in the workshop by the service technician.

After the symptom entry, all the available information is processed. The evaluation takes the form of sequencing and programming on the diagnostic computer in the background. After the processing, the service technician indicates the first test step to a tree structure during strict system guiding. The service technician successively works through the test step tree. If he wishes to loosen up the system guiding, he can display the entire test tree or defined sequences from it. In such a case, the service technician can himself decide which test he selects next, while the tree always predefines the most efficient path. Loosening up the system guidance is appropriate in particular if special tools are required for the tests. If the required tool is not readily available, it may be advantageous to prefer consequential testing. After testing, the test tree has to be corrected according to the result.

The troubleshooting working set are fault candidates. These are represented by a data tuple composed of a suspected component, fault type of the component, fault status and fault probability. The component is not necessarily considered to be a physical component so that software or coding can constitute a fault candidate. The fault type is used in particular to find sporadic faults and will be explained in detail below in the description.

The system uses the symptoms to determine the set of fault candidates K_{Symptom}. This means all the fault candidates which are manifest in the predefined symptom. Specifying the intact functions gives rise to the discounting set [symbol] K_{Symptom}. The processing of data which is internal to the vehicle gives rise to an attributing set of candidates K_{Fahrzeug} and a discounting set of candidates [symbol] K_{Fahrzeug}.

A further information source is the remedy system TIPS/NEWS and the vehicle history which is not integrated into the processing operation until a later time.

The fault candidates which are determined are used to carry out a process of setting off candidates against one another. This process takes place automatically on the diagnostic computer, and in the background. The probabilities which are assigned to the individual fault candidates are used in the setting off process. The objective is to obtain the smallest possible set of suspected fault candidates which is to be checked in the further course of the troubleshooting process.

Fault candidates of the sets [symbol] K_{Fahrzeug}, [symbol] K_{Historie} and [symbol] K_{Symptom} form exclusion elements. The elements included can be used to eliminate previously suspected fault candidates. The elimination is carried out by greatly reducing the probability. For the remaining fault candidates, the elements of the intersection set K_{Fahrzeug} ∩ K_{Symptom} are to be handled with the highest priority. Then, the elements from K_{Symptom} and finally those from K_{Fahrzeug} are to be handled. The underlying matrix can be parameterized. Both the component and the fault type are to be taken into account in the setting off process. The result is an ordered list of fault candidates K.

When the remedy systems TIPS and NEWS are integrated there are further sets which have to be taken into account in the troubleshooting. In order to embed the systems in a structured way they should also provide fault candidates which are included in the setting off of candidates against one another. FIG. 10 illustrates the diagnostic sequence including the processing of TIPS and NEWS information of the remedy systems. After the data which is internal to the vehicle has been read out and the standardized symptoms are available, the system starts an enquiry to the systems TIPS and NEWS. If remedies are available for the given information, the database interrogations provide the suspected fault candidates which are contained in the determined remedies. These fault candidates are incorporated into the setting off of candidates and processed so that in the following step a test step tree can be formed taking into account the fault candidates originating from TIPS and/or NEWS.

Alternatively, TIPS can serve as a pure information source. Instead of the fault candidates which are to be processed further, TIPS then provides a collection of documents. These are displayed to the service technician before he enters the system-guided testing process.

In the next step, the test tree has to be created using the weighted list of fault candidates from the set of candidatesting off process. This step runs automatically and in the background. In the process, the algorithm accesses test step primitives which include the fault candidates tested in the process, the information required for the testing and the repair costs which are incurred. FIG. 11 represents this process step. The tree attempts to minimize the troubleshooting time and the costs of the troubleshooting. In this process, the objective is to create a tree which is as flat as possible. Once the test tree has been created, the first test step is displayed to the service technician and he runs through the individual tests in a guided fashion.

In each test, fault candidates are tested as satisfactory or unsatisfactory. In this way, with each test the service technician narrows down the fault space and thus narrows down K further. If a test results in the exclusion of the tested fault candidates, this actually amounts to discounting. According to this concept this should not take place. The candidate will continue to exist but it is now handled as a sporadic fault candidate. The precise background and the resulting sequence are explained as follows:

The test tree predefines basically the most efficient path for the troubleshooting. This predefinition should therefore be as far as possible conducted in a strict fashion. If the service technician is to be given the freedom to select himself his next test step from the predefined test tree, an iterative process, as indicated in FIG. 10 by means of the dashed line, is unavoidable. The test tree is corrected online as a function of the test carried out last, so that an optimum path can be predefined for every point in time.

Localization of Sporadic Faults

Sporadic faults are generally not diagnosable since they cannot be reproduced. The essential problem here is that a fault is not present at the time when it is tested and as a result the candidate is incorrectly discounted. In order to counteract this, the data tuples of the fault candidates have an additional fault status which is switched over from permanent to sporadic when discounting occurs.

Accordingly, the suspicion is firstly maintained. The candidate has to be tested (again) with respect to the sporadic suspicion. In the case of a line, this means, for example, that through-testing causes the line fault candidate which was previously attributed as permanent to be discounted with the line break fault type. This results in a change in status so that the line candidate remains with the line break fault type and the status sporadic. The suspicion will be completely discounted only when further testing for this case is carried out. The testing pursues the objective of discounting the fault candidate which is suspected of being sporadic. This could be, for example, through-testing of the line with the indication of additional wobbling on the line.

Such tests are certainly associated with significantly high costs so that the tests are used automatically at a later time.

The customer can often make a specification regarding the fault status. The specification is accordingly taken into account in the determination of the fault candidates during the processing of symptoms. The provision of data steers this suspicion. The test step database has to be expanded with test steps for testing candidates suspected of a sporadic fault. The algorithm for the creation of the test step tree coordinates their use.

Optional Methods for Localizing Nonreproducible Faults

At this point, optional system expansions will be proposed.

In the workshop diagnosis which is known from the prior art, the sporadic faults in particular play a significant role. These faults can generally be detected and identified only at the time of their presence. If such a fault is present, the vehicle must remain in the workshop in order to follow up the complaint. The customer loses trust in the competence of the workshop and the product. If the vehicle is kept in the workshop, the troubleshooting gives rise immediately to additional costs for a replacement vehicle. The long-term effects of the driver having to do without his own vehicle cannot be predicted at first. The troubleshooting often extends over a weekend. The customer does not have his vehicle at his disposal while the workshop is not operating on localizing the fault. For this reason, in particular there is a demand for systems which can track the events within the vehicle. Systems which do not require the customer to have to do without his vehicle while the workshop is attempting to find the fault have an additional attraction. The following optional system expansions of the diagnostic system described here present considerable potential for improving the previously known diagnostic systems:
Data logger: with the agreement of the keeper of the vehicle a parameterizable data logger should be used. Depending on the symptom, the logger records important data which is analyzed at a later time centrally or using a special workshop system. There should be a converter for displaying the data in the workshop. In order to save memory, the logger can be realized as a ring buffer which records the data over a defined interval around the time when the fault is detected. The ring buffer can also record data before the fault is reported. Suitable triggers are in a defined fault code or the response-on-event mechanism.
Remote diagnostics: remote diagnostics are considered a supplement to the data logger. The basis of remote diagnostics is a component (vehicle interface) which can be integrated temporarily and is involved in the vehicle communication in a passive way. In addition, further inputs which tap physical measured data directly from the vehicle are conceivable. Furthermore, the component contains a GSM modem for transferring the vehicle data to an external diagnostic device or diagnostic team.

The localization of the fault takes place off board while the customer does not have to do without his vehicle. The fault can be detected by nominal monitoring. Alternatively, vehicle events trigger the diagnostic process. The latter is based on processing usual system messages or the response-on-event mechanism by the control device reacting in an event-oriented fashion.

The start of communication with the vehicle is carried out by the vehicle component or the external diagnostic device or diagnostic team. In future, relatively large quantities of data UMTS can be used for the communication. As already mentioned, the diagnosis can be undertaken by a competent team with the developer's help. Methods which vary on a case-specific basis are available for the automatic diagnostics. While rule-based or model-based methods are available for static cases, automatic state devices or the residue processing, for example, perform the diagnostics for dynamic processes. Evaluation with automatic state devices is based on the possibility of mapping the trajectories of state variables onto nondeterministic or stochastic automatic devices. If the state space is discretized, the system behaves discretely with respect to events. Functional relationships can be represented in a causality graph or Bayes network and correspondingly evaluated.

Temporary Onboard Diagnostics.
Temporary onboard diagnostics represent a further optional expansion for the diagnostic system which is disclosed here and which can make a significant contribution to localizing sporadic faults. It is integrated into the vehicle and performs the system evaluation for the running time of all necessary peripheral conditions. Since contemporary restrictions in terms of the resources in the embedded area do not apply to temporary onboard diagnostics, their full potential cannot be exploited. Relatively large capacities of the available memory resources and computing resources which are possible with temporarily installed devices permit the knowledge bases to be expanded and allow model-based approaches to be used onboard in the vehicle so that even multiple faults can be localized. Stochastic automatic devices or analyses of causal relationships perform the diagnosis for dynamic or functional processes. The result of the onboard diagnostics can be read out again in the workshop and processed further. Alternatively, it is conceivable to combine the temporary onboard diagnostics with remote diagnostics. In this context, the onboard diagnostics performs the preprocessing or pre-evaluation in the vehicle and communicates the results to an external unit.

1. A computer-supported diagnostic system for technical devices having a runnable diagnostic program,
which uses an implemented evaluation algorithm to collect fault-specific technical system data relating to the technical device to be analyzed,
which uses the evaluation algorithm to evaluate and interpret the collected technical system data using a computer-processable model of the technical device and using a technical knowledge base in which the rule-based diagnostic knowledge relating to the technical device to be analyzed is stored for the computer-processable model, and arrives at a diagnostic decision, the diagnostic decision containing a first set of fault candidates which indicates which parts of the technical device are suspected to be faulty,
characterized in that fault symptoms which are observed with a man-machine interface are registered and mapped onto a current, model-based symptom tree,
and in that the evaluation algorithm evaluates and interprets the symptoms of the current standardized symptom tree using system processing and a second symptom-based knowledge base, and determines a second set of fault candidates.

2. The diagnostic system as claimed in claim 1, characterized in that at least one of the two sets of fault candidates for the individual fault candidates contains both attribution features and discounting features.

3. The diagnostic system as claimed in claim 1, characterized in that the fault symptoms are determined from a customer complaint.

4. The diagnostic system as claimed in claim 1, characterized in that the evaluation algorithm sets off the first and second sets of fault candidates against one another.

5. The diagnostic system as claimed in claim 4, characterized in that during the setting off of first and second sets of fault candidates those fault candidates which contain discounting features are excluded.

6. The diagnostic system as claimed in claim 4, characterized in that during the setting off of first and second sets of fault candidates the average set of the two sets of fault candidates is determined.

7. The diagnostic system as claimed in claim 1, characterized in that prioritization is carried out for the fault candidates.

8. The diagnostic system as claimed in claim 1, characterized in that a test step tree is created for the set of fault candidates which is determined.

9. The diagnostic system as claimed in claim 1, characterized in that the structure of the diagnostic system can be expanded with further evaluation algorithms and knowledge bases.

10. The diagnostic system as claimed in claim 1, characterized in that a further set of fault candidates is determined using a remedy system (tips/news).

11. The diagnostic system as claimed in claim 8, characterized in that the test step tree is created from test step primitives.

12. The diagnostic system as claimed in claim 1, characterized in that a further knowledge base relating to the history of the vehicle is included by the evaluation algorithm in the determination of the set of fault candidates.
